(19) United States
(12) Patent Application Publication
(10) Pub. No.: US 2011/0143759 A1
(43) Pub. Date: Jun. 16, 2011

(54) METHOD OF PERFORMING HANDOVER IN WIRELESS COMMUNICATION SYSTEM

(76) Inventors: Yong Seouk CHOI, (US); Sook Jin Lee, (US)

(21) Appl. No.: 12/968,425

(22) Filed: Dec. 15, 2010

(30) Foreign Application Priority Data
Dec. 15, 2009 (KR) 10-2009-0124884
Jul. 23, 2010 (KR) 10-2010-0071587

(51) Int. Cl. H04W 36/00

(52) U.S. Cl. 455/444

(57) ABSTRACT

A method in which a terminal performs handover is provided. The method includes: receiving a broadcast message including system information from at least one femto base station; detecting at least one candidate femto base station using the broadcast message; transmitting a handover request message including information of the at least one candidate femto base station based on the system information to the macro base station; receiving a handover response message to the handover request message from the macro base station; and performing handover to a target femto base station of the at least one candidate femto base station based on information that is included in the handover response message.

### CROSS-REFERENCE TO RELATED APPLICATION

This application claims priority to and the benefit of Korean Patent Application Nos. 10-2009-0124884 and 10-2010-0071587 filed in the Korean Intellectual Property Office on Dec. 15, 2009 and Jul. 23, 2010, the entire contents of which are incorporated herein by reference.

### BACKGROUND OF THE INVENTION

(a) Field of the Invention

The present invention relates to a method of performing handover between a femto base station and a macro base station.

(b) Description of the Related Art

Nowadays, research regarding a base station that manages small cells within a macro cell area has been actively performed. Such a small cell is referred to as a femto cell, and a base station that manages the femto cell is referred to as a femto base station. For example, when the femto base station is installed indoors, a user of a mobile communication system may receive a service through a macro base station outdoors and receive a service through the femto base station indoors.

However, the femto base station has a structure of a small cell radius, for example, about 30 m, and many femto base stations can be installed within a macro cell area. Therefore, in an environment where the macro base station and the femto base station coexist, when the terminal enters from the macro base station to the femto base station or when the terminal enters from the femto base station to the macro base station, a handover procedure between existent macro base stations cannot be used. Accordingly, a method of performing handover between the macro base station and the femto base station is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of performing handover in a wireless communication system having advantages of performing handover between a macro base station and a femto base station.

An exemplary embodiment of the present invention provides a method in which a terminal performs handover, the method including: receiving a broadcast message including system information from at least one femto base station; detecting at least one candidate femto base station using the broadcast message; transmitting a handover request message including information of the at least one candidate femto base station based on the system information to the macro base station; receiving a handover response message to the handover request message from the macro base station; and performing handover to a target femto base station of the at least one candidate femto base station based on information that is included in the handover response message.

Another embodiment of the present invention provides a method in which a macro base station performs handover, the method including: receiving a handover request message including system information about a target femto base station from a terminal; acquiring a parameter by performing association for handover with the target femto base station; and transmitting a handover response message including the parameter to the terminal.

Yet another embodiment of the present invention provides a method in which a terminal performs handover in a wireless communication system, the method including: transmitting a handover request message including cell identification information of a macro base station that has been connected before being connected to a femto base station, to the femto base station; receiving a handover response message to the handover request message from the femto base station; and performing handover to the macro base station based on information that is included in the handover request message.

Yet another embodiment of the present invention provides a method in which a femto base station performs handover, the method including: receiving a handover request message including cell identification information of a base station that has been connected before being connected to a serving femto base station; performing, by the serving femto base station, association for handover with a target macro base station and acquiring a parameter for setting a connection association; and transmitting, by the serving femto base station, the parameter for setting the connection to the terminal.

### BRIEF DESCRIPTION OF THE DRAWINGS

FIG. 1 is a diagram schematically illustrating a wireless communication system including a femto base station.

FIG. 2 is a flowchart illustrating operation in a process where a terminal according to an exemplary embodiment of the present invention enters from a macro base station to a femto base station.

FIG. 3 is a flowchart illustrating a process where a terminal, a macro base station, and a femto base station perform handover in a process where a terminal according to an exemplary embodiment of the present invention enters from the macro base station to the femto base station.

FIG. 4 is a flowchart illustrating operation in a process where a terminal according to an exemplary embodiment of the present invention enters from a femto base station to a macro base station.

FIG. 5 is a flowchart illustrating a process where a terminal, a macro base station, and a femto base station perform handover in a process where a terminal according to an exemplary embodiment of the present invention enters from the femto base station to the macro base station.

FIG. 6 is a block diagram illustrating a terminal, a macro base station, and a femto base station that embody a handover procedure according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

In this specification, a mobile station (MS) may indicate a terminal, a mobile terminal (MT), a subscriber station (SS), a portable subscriber station (PSS), user equipment (UE), and an access terminal (AT), and may include an entire function or a partial function of the MS, the terminal, the MT, the SS, the PSS, the UE, and the AT.

In this specification, a base station (BS) may indicate an access point (AP),DeletedTextsa radio access station (RAS), a node B, an evolved nodeB (eNodeB), a base transceiver station (BTS), and a mobile multihop relay (MMR)-BS, and may include an entire function or a partial function of the BS, the AP, the RAS, the node B, the eNodeB, the BTS, and the MMR-BS.

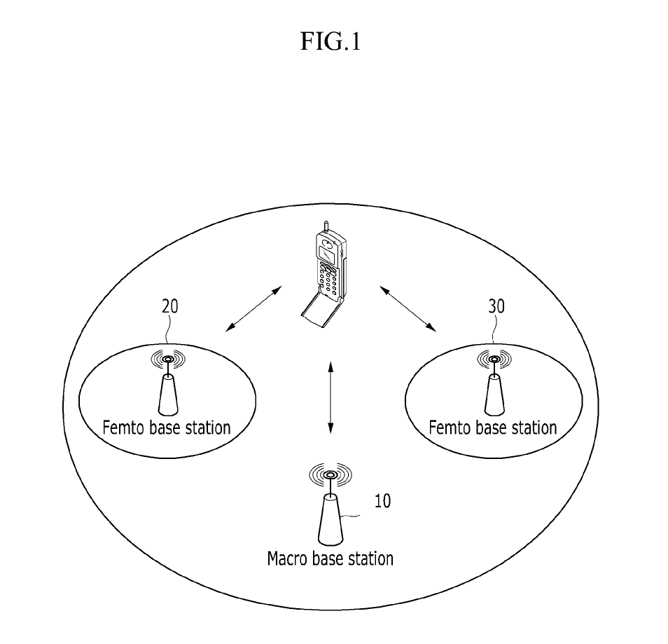

FIG. 1 is a diagram schematically illustrating a wireless communication system including a femto base station.

Referring to FIG. 1, a plurality of femto base stations 20 and 30 exist within a cell of a macro base station 10. The macro base station has a wide cell radius, and the femto base station is connected to the macro base station through a backbone connection, communicates with a self network capacity, and has a small cell radius. The femto base station can be turned on/off, unlike the macro base station, and can operate in a sleep mode in order to save power.

There are various problems in applying a handover procedure between general macro base stations to a handover procedure between the macro base station and the femto base station. That is, because many femto base stations exist in a macro base station, neighborhood base stations that are listed in an MOB_NBR-ADV message increase, and overhead of a terminal and the base station that should manage the neighborhood base stations increases. Because neighborhood base stations that are formed in a list increase, a possibility that an error may occur in managed information increases. In order for the terminal to scan all neighborhood base stations that are formed in a list, much time is required. Therefore, a handover method corresponding to characteristics of the femto base station is required. First, a handover method in a process where the terminal enters from the macro base station to the femto base station will be described.

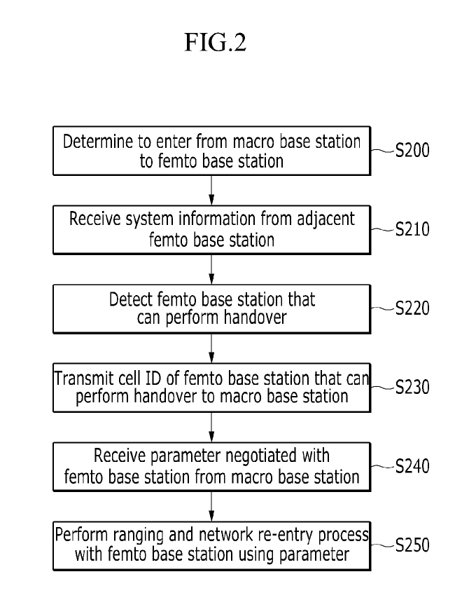

FIG. 2 is a flowchart illustrating operation in a process where a terminal according to an exemplary embodiment of the present invention enters from a macro base station to a femto base station. It is assumed that the terminal is normally connected to the macro base station.

Referring to FIG. 2, the terminal determines to enter from the macro base station to the femto base station (S200). In this case, the terminal can know to enter the femto base station using intensity of a received signal.

The terminal triggers handover, and the terminal receives system information from an adjacent femto base station (S210). The system information includes cell identification information, for example, a cell ID of the femto base station.

The terminal detects a femto base station that can perform handover using system information that is received from the femto base station (S220).

The terminal transmits a handover request message to the femto base station to the macro base station (S230). In this case, the handover request message includes cell identification information of the femto base station that can perform handover.

The terminal receives a handover response message to the femto base station from the macro base station (S240). The handover response message includes a parameter that the macro base station obtains by negotiating with the femto base station. The parameter includes handover optimization (HO optimization) information when the terminal performs handover from the macro base station to the femto base station.

The terminal performs a ranging and network re-entry process with the femto base station using a parameter that is received from the macro base station (S250).

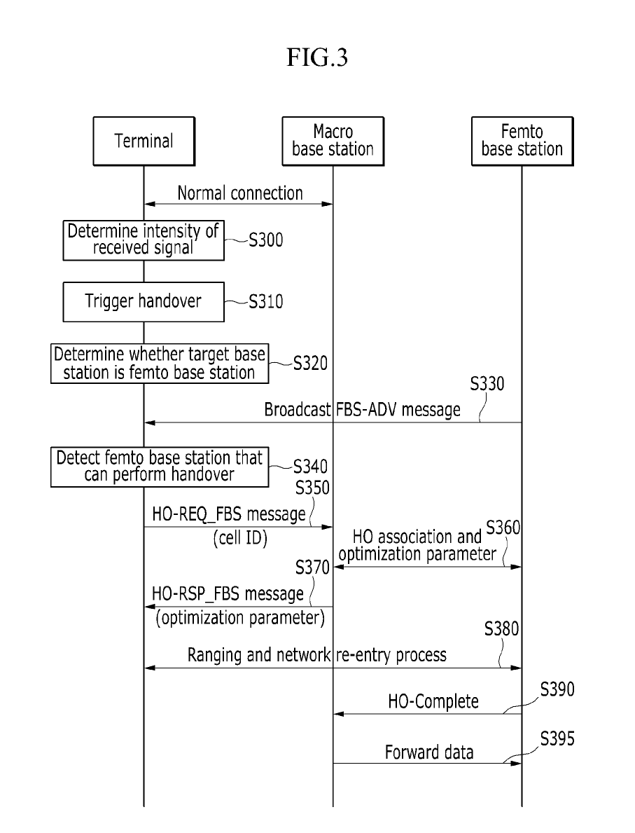

FIG. 3 is a flowchart illustrating a process where a terminal, a macro base station, and a femto base station perform handover in a process where a terminal according to an exemplary embodiment of the present invention enters from the macro base station to the femto base station. It is assumed that the terminal is in a normal connection state with the macro base station.

Referring to FIG. 3, the terminal determines intensity of a received signal (S300). The terminal can measure intensity of a received signal in real time. The received signal indicates a signal that is received from a femto base station and a macro base station that are positioned adjacent to the terminal as well as a macro base station to which the terminal is normally connected.

The terminal triggers handover using the measured intensity of the received signal (S310). As the terminal approaches a coverage area of a new base station, intensity of a received signal that is received from a macro base station in an existing connection state decrease, and intensity of a received signal that is received from a new base station increases. When a change amount of intensity of the received signal surpasses a predetermined reference value, the terminal triggers handover.

When handover is triggered, the terminal determines whether a newly entering base station is the macro base station or the femto base station (S320). For example, the terminal can distinguish the femto base station using an A-preamble that is periodically transmitted by the femto base station that is positioned adjacent to the terminal.

When a base station in which the terminal newly enters is the femto base station, the terminal receives a femto base station-advertisement (FBS-ADV) message from at least one femto base station adjacent to the terminal (S330). The FBS-ADV message is a message that the femto base station periodically broadcasts, and includes system information of the femto base station. The system information includes cell identification information of the femto base station.

The terminal detects a femto base station that can perform handover using intensity of a received signal that is determined at step S300 and a FBS-ADV message that is received at step S330 (S340). The quantity of femto base stations that can perform handover may be two or more.

The terminal transmits a handover request to femto base station (HO-REQ FBS) message that requests handover to the femto base station to the macro base station (S350). The HO-REQ_FBS message includes cell identification information of a femto base station that is detected as the femto base station that can perform handover. When the quantity of femto base stations that are detected as the femto base station that can perform handover is plural, the terminal may include cell identification information that is formed in a list in the HO-REQ_FBS message and transmit the HO-REQ_FBS message.

The macro base station, having received the HO-REQ_FBS message from the terminal, selects a femto base station that can perform handover and performs HO association for handover through a backhaul network (S360). The macro base station can select a femto base station that can perform handover based on cell identification information that is included in the HO-REQ_FBS message. That is, the macro base station selects all or some of the femto base stations corresponding to the cell identification information that is included in the HO-REQ_FBS message as the femto base station that can perform handover, and can perform HO association for handover. In an HO association process for handover, the macro base station collects a parameter for ranging and network re-entry between the terminal and the femto base station from the femto base station.

The macro base station transmits a handover-response femto base station (HO-RSP_FBS) message, which is a response message to the HO-REQ_FBS message to the terminal (S370). The HO-RSP_FBS message includes a parameter that the macro base station acquires from the femto base station.

The terminal performs a ranging and network re-entry process with the femto base station using a parameter that is included in the HO-RSP_FBS message (S380).

After a network resetting process is complete, the femto base station transmits a handover complete (HO_complete) message to the macro base station (S390).

The macro base station, having received a handover complete message from the femto base station forwards traffic data that have been sustained for a handover period to the femto base station (S395). The femto base station can minimize data loss that may occur when performing handover by transmitting the forwarded data to the terminal.

Next, a method of performing handover in a process where the terminal enters from the femto base station to the macro base station will be described.

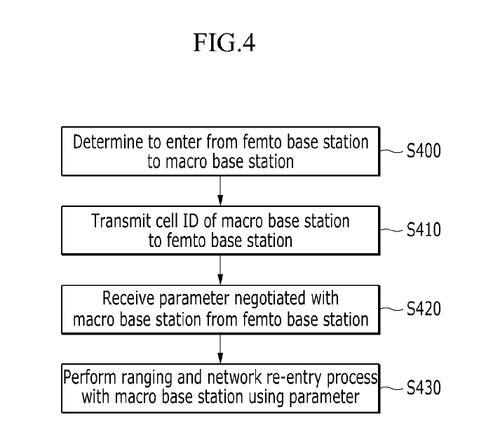

FIG. 4 is a flowchart illustrating operation in a process where a terminal according to an exemplary embodiment of the present invention enters from a femto base station to a macro base station. It is assumed that the terminal is normally connected to the femto base station and enters the macro base station that has been connected before entering the femto base station.

Referring to FIG. 4, the terminal determines to enter from the femto base station to the macro base station (S400). In this case, the terminal can know to enter the macro base station using intensity of a received signal.

The terminal triggers handover and transmits a handover request message to the macro base station to the femto base station (S410). In this case, the handover request message includes a cell ID of the macro base station to enter. The terminal can store a cell ID of the macro base station that has been connected before entering the femto base station and use the stored cell ID when entering again the macro base station after escaping from the femto base station.

The terminal receives a handover response message to the macro base station from the femto base station (S420). The handover response message includes a parameter that is acquired when the femto base station negotiates with the macro base station. The parameter includes HO optimization information in order for the terminal to perform handover from the femto base station to the macro base station.

The terminal performs a ranging and network re-entry process with the macro base station using a parameter that is received from the femto base station (S430).

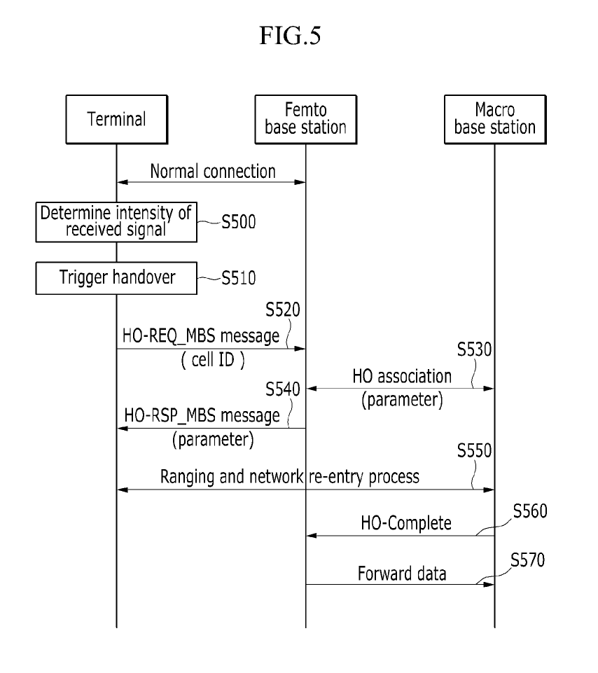

FIG. 5 is a flowchart illustrating a process where a terminal, a macro base station, and a femto base station perform handover in a process where a terminal according to an exemplary embodiment of the present invention enters from the femto base station to the macro base station. It is assumed that the terminal is in a normal connection state with the femto base station.

Referring to FIG. 5, the terminal measures intensity of a received signal in real time (S500). The received signal indicates a signal that is received from a macro base station and a femto base station that are positioned adjacent to the terminal as well as a femto base station to which the terminal is normally connected.

The terminal triggers handover using the measured intensity of the received signal (S510). That is, when the terminal in a connection state with the femto base station tries to escape coverage of the femto base station, the intensity of a signal that is received from the femto base station decreases, and the intensity of a signal that is received from a newly entered base station increases. When a change in intensity of the received signal surpasses a predetermined reference value, the terminal triggers handover.

When handover is triggered, the terminal transmits a handover request message to the macro base station (HO-REQ_MBS) that requests handover to the macro base station to the femto base station (S520). The HO-REQ_MBS message includes cell identification information of the macro base station. The terminal stores cell identification information of the macro base station that has been connected before entering the femto base station, and includes the stored cell identification information in the HO-REQ_MBS message when again entering the macro base station and transmits the HO-REQ_MBS message.

The femto base station, having received the HO-REQ_MBS message from the terminal, performs HO association for handover through the macro base station and the backhaul network (S530). In an HO association process for handover, the femto base station can collect a parameter for ranging and network re-entry between the terminal and the macro base station from the macro base station. The terminal can previously receive a resource for ranging with the macro base station through an association process. Therefore, the terminal can perform non-contention-based ranging with the macro base station.

The femto base station transmits a handover-response macro base station (HO-RSP_MBS) message, which is a response message to a HO-REQ_MBS message to the terminal (S540). The HO-RSP_MBS message includes a parameter that the femto base station acquires from the macro base station.

The terminal performs a ranging and network re-entry process with the macro base station using the parameter that is included in the HO-RSP_MBS message (S550).

After a network re-entry process is complete, the macro base station transmits a handover complete message to the femto base station (S560).

The femto base station, having received a handover complete message from the macro base station, forwards traffic data that have been sustained for a handover period to the macro base station (S570). The macro base station transmits the forwarded data to the terminal, thereby minimizing data loss that may occur when performing handover.

In the foregoing description, a handover procedure when the terminal enters from the macro base station to the femto base station or when the terminal enters from the femto base station to the macro base station is described. The above-described handover procedure can be applied even to a case where the terminal enters from the femto base station to another femto base station. For example, after a handover procedure is performed from the femto base station to the macro base station according to a method that is described in FIGS. 4 and 5, a handover procedure may be performed from the macro base station to the femto base station according to a method that is described in FIGS. 2 and 3.

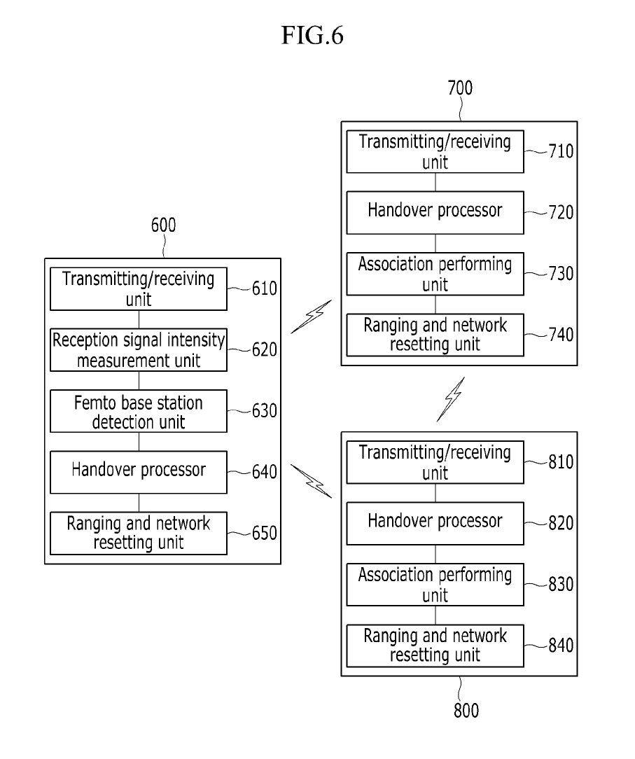

FIG. 6 is a block diagram illustrating a terminal, a macro base station, and a femto base station that embody a handover procedure according to an exemplary embodiment of the present invention.

Referring to FIG. 6, a terminal 600 includes a transmitting/receiving unit 610, a reception signal intensity measurement unit 620, a femto base station detection unit 630, a handover processor 640, and a ranging and network resetting unit 650.

A macro base station 700 includes a transmitting/receiving unit 710, a handover processor 720, an association performing unit 730, and a ranging and network resetting unit 740.

A femto base station 800 includes a transmitting/receiving unit 810, a handover processor 820, an association performing unit 830, and a ranging and network resetting unit 840.

When the terminal 600 enters from the macro base station 700 to the femto base station 800, the reception signal intensity measurement unit 620 of the terminal 600 determines that the terminal 600 enters from the macro base station 700 to the femto base station 800 using a measurement result of intensity of the received signal. The transmitting/receiving unit 610 of the terminal 600 receives a broadcast message including system information from at least one femto base station 800 adjacent to the terminal 600. The femto base station detection unit 630 of the terminal 600 detects the femto base station 800 that the terminal 600 is to enter. The handover processor 640 of the terminal 600 transmits a handover request message that requests handover to the detected femto base station 800 to the macro base station 700. The handover request message includes system information, for example cell identification information, of the femto base station 800. When a handover request message is received, the association performing unit 730 of the macro base station 700 performs association with the association performing unit 830 of the femto base station 800, and the transmitting/receiving unit 710 of the macro base station 700 transmits a parameter that is acquired as a performance result of association to the terminal 600. The ranging and network resetting unit 650 of the terminal 600 performs ranging and network resetting processing with the ranging and network resetting unit 840 of the femto base station 800 using the received parameter. The handover processor 820 of the femto base station 800 transmits a handover complete message to the macro base station 700, and the transmitting/receiving unit 710 of the macro base station 700 forwards data that have been sustained for a handover period to the femto base station 800.

When the terminal 600 enters from the femto base station 800 to the macro base station 700, the reception signal intensity measurement unit 620 of the terminal 600 determines that the terminal 600 enters from the femto base station 800 to the macro base station 700 using a measurement result of intensity of the received signal. The handover processor 640 of the terminal 600 transmits a handover request message that requests handover to the macro base station 700 to the femto base station 800. The handover request message includes system information, for example cell identification information, of the macro base station 700. The system information of the macro base station 700 may be system information of the macro base station 700 that has been connected before the terminal 600 enters the femto base station 800. When the handover request message is received, the association performing unit 830 of the femto base station 800 performs association with the association performing unit 730 of the macro base station 700, and the transmitting/receiving unit 810 of the femto base station 800 transmits a parameter that is acquired as an association performance result to the terminal 600. The ranging and network resetting unit 650 of the terminal 600 performs ranging and network resetting processing with the ranging and network resetting unit 740 of the macro base station 700 using the received parameter. The handover processor 720 of the macro base station 700 transmits a handover complete message to the femto base station 800, and the transmitting/receiving unit 810 of the femto base station 800 forwards data that have been sustained for a handover period to the macro base station 700.

An efficient handover method when the terminal enters from the macro base station to the femto base station or when the terminal enters from the femto base station to the macro base station is provided.

The foregoing exemplary embodiment of the present invention may not only be embodied through an apparatus and a method, but may also be embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a terminal performs handover, the method comprising:
receiving a broadcast message including system information from at least one femto base station;
detecting at least one candidate femto base station using the broadcast message;
transmitting a handover request message including information of the at least one candidate femto base station based on the system information to the macro base station;
receiving a handover response message to the handover request message from the macro base station; and
performing handover to a target femto base station of the at least one candidate femto base station based on information that is included in the handover response message.

2. The method of claim 1, further comprising:
receiving a signal from the macro base station and at least one femto base station adjacent to the terminal; and
triggering handover based on intensity of the received signal.

3. The method of claim 2, wherein when a difference in intensity of the received signal between the at least one femto base station and the macro base station is a threshold value or more, the handover is triggered.

4. The method of claim 1, wherein the system information comprises cell identification information of each femto base station.

5. The method of claim 1, wherein the information of the at least one candidate femto base station comprises cell identification information of the at least one candidate femto base station.

6. The method of claim 1, wherein the information that is included in the handover response message comprises a parameter for performing a connection setting procedure with the target femto base station.

7. A method in which a macro base station performs handover, the method comprising:
receiving a handover request message including system information about a target femto base station from the terminal;
acquiring a parameter by performing association for handover with the target femto base station; and
transmitting a handover response message including the parameter to the terminal.

8. The method of claim 7, wherein the system information is included in a message that the target femto base station periodically broadcasts.

9. The method of claim 7, wherein the system information comprises cell identification information of the target femto base station.

10. The method of claim 7, further comprising:
receiving a handover complete message from the target femto base station; and
forwarding traffic data that have been sustained for a handover period to the target femto base station.

11. A method in which a terminal performs handover in a wireless communication system, the method comprising:
transmitting a handover request message including cell identification information of a macro base station that has been connected before being connected to a femto base station, to the femto base station;
receiving a handover response message for the handover request message from the femto base station; and
performing handover to the macro base station based on information that is included in the handover request message.

12. The method of claim 11, wherein the information that is included in the handover response message comprises a parameter for performing a connection setting procedure.

13. The method of claim 12, wherein the parameter is acquired when the femto base station performs association with the macro base station.

14. A method in which a femto base station performs handover, the method comprising:
receiving a handover request message including cell identification information of a base station that has been connected before being connected to a serving femto base station;
performing, by the serving femto base station, association for handover with a target macro base station and acquiring a parameter for setting a connection; and
transmitting, by the serving femto base station, the parameter for setting the connection to the terminal.

15. The method of claim 14, further comprising:
transmitting, by the serving femto base station, the parameter to the terminal and then receiving a handover complete message from the target macro base station; and
forwarding, by the serving femto base station, traffic data that have been sustained for a handover period to the target macro base station.
